(19) United States
(12) Patent Application Publication
(10) Pub. No.: US 2007/0128339 A1
(43) Pub. Date: Jun. 7, 2007

(54) Nutrient modified food composition

(76) Inventor: Roy J. Mankovitz, Montecito, CA (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/296,127

(22) Filed: Dec. 7, 2005

(51) Int. Cl. A23J 1/00

(52) U.S. Cl. 426/656

(57) ABSTRACT

Food compositions are described according to the invention which have specified nutrient content modification. In particular, food compositions intended for human consumption are provided having added L-lysine and a specified ratio of L-lysine content to L-arginine content. For example, a food composition intended for human consumption is provided which includes a food having more endogenous L-arginine than endogenous L-lysine, and an amount of added L-lysine such that the amount of added L-lysine in combination with the amount of endogenous L-lysine is sufficient to equal or exceed the amount of endogenous L-arginine. The added L-lysine is applied to the food such that it is ingested along with the food. Processes for producing a nutrient modified food composition are also provided, along with food products which include a nutrient modified food composition.

### FIELD OF THE INVENTION

This invention relates to food compositions having specified nutrient contents. In particular, the invention relates to food compositions intended for human consumption having added L-lysine and a specified ratio of L-lysine content to L-arginine content.

### BACKGROUND OF THE INVENTION

Herpes simplex virus (HSV) infection is a continuing human health problem. There are multiple types of the virus, including Herpes Simplex Virus type 1 (HSV1) and Herpes Simplex Virus type 2 (HSV2). HSV causes recurrent lesions in infected individuals with negative emotional and physical consequences. Currently, nearly one-fifth of the total adolescent and adult population of the U.S. is estimated to be infected with HSV2.

There is no known cure for HSV infection, so treatments focus on accelerating healing of lesions. However, many infected individuals would prefer to prevent or lessen recurrence of lesions.

Some progress has been made in understanding outbreaks of HSV lesions. The amino acid L-arginine has been identified as an agent promoting replication of HSV in vitro. Further, the essential amino acid L-lysine appears to antagonize the growth promoting effects of L-arginine in vitro.

Such experimental results have resulted in a recommendation of diets rich in L-lysine and low in L-arginine to patients suffering from HSV infection. However, such dietary changes are often hard to manage.

For instance, infected individuals may be advised to avoid foods rich in L-arginine, such as tree nuts, peanuts, chocolate and various fruit juices. However, this results in deprivation of the nutritional and experiential benefits of these foods, making compliance with recommended restrictions less likely, and even unhealthy.

Another course of action, supplementing the diet with L-lysine, may be accomplished by taking capsules or tablets of L-lysine. However, such self-dosing is done without accounting for the specific amounts of L-arginine consumed. Further, where supplemental L-lysine is taken at times other than meal times, the timing of L-lysine uptake from the gut may not be coincident with presence of dietary L-arginine in the gut, negating any beneficial effect exerted through inhibition by competition for a common transporter.

Thus, there is a continuing need for compositions and methods for use in dietary supplementation. In particular, compositions and methods are required for providing a food composition modified with respect to a ratio of L-arginine and L-lysine content.

### SUMMARY OF THE INVENTION

A food composition intended for human consumption is provided which includes a food having more endogenous L-arginine than endogenous L-lysine, and an amount of added L-lysine such that the amount of added L-lysine in combination with the amount of endogenous L-lysine is sufficient to equal or exceed the amount of endogenous L-arginine. The added L-lysine is applied to the food such that it is ingested along with the food. The ratio of the amount of endogenous L-lysine to the amount of endogenous L-arginine in the food is in the range between 0.01:1-0.99:1. In one embodiment, the ratio of the amount of endogenous L-lysine to the amount of endogenous L-arginine is in the range between 0.025:1-0.6:1. In a further embodiment, the ratio of the amount of endogenous L-lysine to the amount of endogenous L-arginine is in the range between 0.05:1-0.5:1. The added L-lysine is preferably substantially free of L-arginine.

The ratio of amount of added L-lysine in combination with the amount of endogenous L-lysine to the amount of endogenous L-arginine is in the range between 1:1-50:1.

The added L-lysine may include an inorganic salt of L-lysine and/or an organic salt of L-lysine. An optional flavoring and/or sweetener may be added to enhance the taste of the food composition.

In certain embodiments, the food is a tree nut or a tree nut product, such as a tree nut milk or a tree nut butter. Exemplary tree nuts include almonds, Brazil nuts, cashews, chestnuts, hazelnuts, macadamia nuts, pecans, pine nuts, pistachios, and walnuts.

In further embodiments, the food is a peanut or a peanut product, such as peanut milk or peanut butter. The food may also be an edible seed, such as a sunflower seed or pumpkin seed in certain embodiments.

Also provided is a food product which includes a food composition according to an embodiment of the invention.

A method of producing a nutrient modified food composition is detailed which includes providing a food having less endogenous L-lysine than endogenous L-arginine and applying an amount of exogenous L-lysine to the food, so that the amount of exogenous L-lysine in combination with the amount of endogenous L-lysine is sufficient to equal or exceed the amount of endogenous L-arginine.

In a further embodiment, a food composition intended for human consumption is provided which includes a food having less endogenous L-lysine than endogenous L-arginine with the proviso that the food is not a grain. The food composition further includes an amount of added L-lysine which is substantially free of L-arginine, and which, in combination with the amount of endogenous L-lysine, is sufficient to equal or exceed the amount of endogenous L-arginine.

### DETAILED DESCRIPTION OF THE INVENTION

A food composition intended for human consumption is provided according to an embodiment of the present invention which includes a food having less L-lysine than L-arginine. An amount of L-lysine is added to the food such that the resulting food composition has equal amounts of L-arginine and L-lysine or more L-lysine than L-arginine.

In one embodiment, a food included in a food composition according to the present invention has a ratio of the amount of endogenous L-lysine to the amount of endogenous L-arginine in the range between 0.01:1-0.99:1. In further embodiments this ratio is in the range between 0.025:1-0.6:1. In additional embodiments, the ratio is in the range between 0.05:1-0.5:1.

Foods having less L-lysine than L-arginine include tree nuts such as almonds, Brazil nuts, cashews, chestnuts, hazelnuts, macadamia nuts, pecans, pine nuts, pistachios, and walnuts. In a preferred embodiment, tree nuts are provided as a snack food in the form of shelled whole nuts or shelled nut pieces, but the invention also applies to nuts and seeds in their shell. Nuts may also be used in the form of a nut milk. Nut milks typically include nuts and water blended in a ratio so as to provide a drinkable liquid. A suitable ratio of nuts:water is in the range of about 1:2-1:8, preferably about 1.3-1.5. Tree nut butters are another form of food optionally included in an inventive composition. Such nut butters typically include ground tree nuts and an oil, mixed to produce a viscous spreadable substance.

Peanuts have less L-lysine than L-arginine and are preferably provided in one embodiment as a snack food as shelled whole nuts or shelled nut pieces, although the invention also applies to peanuts in their shell.

Suitable foods also include peanut milks, including peanuts and water blended in a ratio so as to provide a drinkable liquid. A suitable ratio of peanuts:water is in the range of about 1:2-1:8, preferably about 1.3-1.5. Optionally, peanut butters are another form of food optionally included in an inventive composition. Such nut butters typically include peanuts and an oil, mixed to produce a viscous spreadable substance.

Edible plant seeds, such as sunflower and pumpkin seeds, are another category of food to which this invention may be applied, in a manner analogous to that of tree nuts as described above. L-lysine may be applied to edible plant seeds in the shell or shelled.

Fruits and fruit juices are foods having less L-lysine than L-arginine and are included in inventive compositions in certain embodiments of the invention.

In general, grains such as rice or barley are not preferred as foods to which L-lysine is added for use in a food composition according to the invention.

L-lysine may be added or applied to a food as the free base, a non-toxic salt, or a mixture thereof. In one embodiment, a preferred L-lysine salt is an inorganic salt. Inorganic L-lysine salts illustratively include an L-lysine hydrochloride such as L-lysine monohydrochloride and L-lysine dihydrochloride; and L-lysine phosphate such as L-lysine monophosphate; an alkaline metal L-lysine diphosphate such as sodium L-lysine diphosphate; and L-lysine sulfate.

In one embodiment, an organic salt of L-lysine is included in an inventive composition. In one embodiment, an organic carboxylic acid salt of L-lysine is a substituted or unsubstituted C₁-C₈ monocarboxylic or dicarboxylic acid salt. Such organic salts may be substituted with a moiety illustratively including a hydroxyl group, a carboxyl group, a C₁-C₄ alkyl group, a phosphorus-containing group, a sulfur-containing group, a nitrogen-containing group and/or an oxygen-containing group.

C₁-C₈ monocarboxylic acid salts illustratively include L-lysine acetate, L-lysine propionate and L-lysine sorbate. In a further embodiment, an organic carboxylic acid salt of L-lysine is a C₁-C₈ hydoxyl-substituted dicarboxylic acid salt illustratively including L-lysine tartrate and L-lysine malate. An organic carboxylic acid salt of L-lysine may further be a C₁-C₈ hydoxyl-substituted, carboxyl-substituted dicarboxylic acid salt illustratively including L-lysine citrate. In another embodiment, an organic carboxylic salt of L-lysine may be an unsubstituted C₁-C₈ dicarboxylic acid salt illustratively including L-lysine malonate and L-lysine succinate.

L-lysine may be obtained for addition to a food by isolation, such as by acid hydrolysis of lysine-containing protein, followed by purification. L-lysine may also be synthesized. Food grade L-lysine is commercially available from various sources. While L-lysine may be added as a component of an amino acid mixture, it is highly preferred that no arginine is added to the food.

The amount of added L-lysine in combination with the amount of endogenous L-lysine is the total amount of L-lysine in a food composition as provided by the present invention. The ratio of the total amount of L-lysine to the amount of endogenous L-arginine is in the range between 1:1-50:1. In a further embodiment, this ratio is in the range of 1.1:1-20:1. In additional embodiments, this ratio is in the range of 1.2:1-10:1.

Addition of L-lysine to a food includes contacting the food and a desired amount of L-lysine such that the L-lysine is retained in contact with the food and may be ingested along with the food.

For example, a food is contacted with a desired amount of L-lysine in any of various formulation types, including a liquid, solid, emulsion or gel. Illustratively, the L-lysine may be mixed in a food and/or topically applied as a coating or partial coating. In a preferred embodiment, added L-lysine is formulated as an additive which is substantially free of L-arginine.

L-lysine may be solubilized or suspended in an aqueous or nonaqueous solvent for use in mixing or applying the L-lysine to a food. Exemplary solvents include water, alcohols, glycerol and other edible solvents, and combinations of these. Optionally, one or more edible oils may be used to solubilize or suspend the L-lysine.

Various excipients may be included in an L-lysine formulation. For example, one or more of the following may be included: a binder, an emulsifying agent, a gelling agent, a buffering agent, a flavoring, and a sweetener.

L-lysine may be applied as a coating using conventional coating methods and equipment. For example, suitable methods of applying L-lysine include using a coating pan, a spray technique, or fluidized bed coating.

Where L-lysine is applied to a food which is modified before eating, the amount of added L-lysine refers to the amount of added L-lysine associated with the ingested food such that ingested amount of L-lysine is equal to or greater than the amount of ingested L-arginine. Thus, for example, peanuts in the shell are modified before eating by removal of the shell in most cases. Peanuts in the shell may have L-lysine added by various methods, such as application of an L-lysine solution to the peanuts in the shell under pressure to draw the L-lysine through the shells and onto the peanuts inside as in standard salting processes. Such a process may result in L-lysine deposited on the shell as well as on the peanut inside. The amount of L-lysine deposited onto the peanut inside as well as the amount deposited on the shell in such a process may be determined empirically in order to establish the amount of L-lysine necessary to achieve the desired amount of ingested L-lysine in contact with the peanut.

A food composition may be added to one or more additional foods to produce a food product. It is preferred that there are equal amounts of L-lysine and L-arginine in the food product, or preferably, more L-lysine than L-arginine. Highly preferred is a food product having a ratio of the total amount of L-lysine to the amount of endogenous L-arginine in the range between 1:1-50:1. In a further embodiment, this ratio is in the range of 1.1:1-20:1. In additional embodiments, this ratio is in the range of 1.2:1-10:1.

A method of producing a nutrient modified food composition is provided by the present invention which includes providing a food having an amount of endogenous L-lysine and an amount of endogenous L-arginine, wherein the amount of endogenous L-lysine is less than the amount of endogenous L-arginine. Such a method further includes applying an amount of exogenous L-lysine to the food, the amount of exogenous L-lysine in combination with the amount of endogenous L-lysine sufficient to equal or exceed the amount of endogenous L-arginine, thereby producing a nutrient modified food composition.

Amounts of L-lysine, L-arginine and other amino acids and nutrients in a food may be determined by chemical analysis. For example, amino acid content in foods may be determined by enzyme and/or chemical hydrolysis of protein in conjunction with an analytic technique such as gas-liquid chromatography or HPLC. Amino acid content of foods may also be determined from references such as Orr, M. L. and Watt, B. K., Amino Acid Content of Foods, Agricultural Research Service, USDA, U.S. Government Printing Office, 1957.

### EXAMPLE

Almonds are prepared as a snack food according to a method of the present invention. Since 100 g of almonds contain 0.58 g L-lysine and 2.73 g L-arginine this food has a ratio of endogenous L-lysine: endogenous L-arginine of 0.21:1. In order to obtain a nutritionally balanced food composition exogenous L-lysine is added to the individual samples of 100 g of almonds in various amounts sufficient to equal or exceed the amount of endogenous L-arginine.

2.15 g of L-lysine is dissolved in a tacky solvent, such as an aqueous solution containing glycerol and applied to 100 g of almonds to produce a food composition having a 1:1 ratio of total lysine:endogenous arginine. Food compositions having higher ratios of total lysine:endogenous arginine may be produced similarly.

Any patents or publications mentioned in this specification are incorporated herein by reference to the same extent as if each individual publication is specifically and individually indicated to be incorporated by reference.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

I claim:

1. A food composition intended for human consumption, comprising, in combination:
a food having an amount of endogenous L-lysine and an amount of endogenous L-arginine, wherein the amount of endogenous L-lysine is less than the amount of endogenous L-arginine; and
an amount of added L-lysine, the amount of added L-lysine in combination with the amount of endogenous L-lysine sufficient to equal or exceed the amount of endogenous L-arginine.

2. The food composition of claim 1 wherein a ratio of the amount of endogenous L-lysine to the amount of endogenous L-arginine is in the range between 0.01:1-0.99:1.

3. The food composition of claim 1 wherein a ratio of amount of added L-lysine in combination with the amount of endogenous L-lysine to the amount of endogenous L-arginine is in the range between 1:1-50:1.

4. The food composition of claim 1 wherein the added L-lysine is substantially free of L-arginine.

5. The food composition of claim 1 wherein the added L-lysine comprises an inorganic salt of L-lysine.

6. The food composition of claim 1 wherein the added L-lysine comprises an organic salt of L-lysine.

7. The food composition of claim 1 wherein the organic salt is selected from the group consisting of: a C₁-C₈ monocarboxylic salt, a C₁-C₈ dicarboxylic salt and a combination thereof.

8. The food composition of claim 1 wherein the added L-lysine comprises an organic salt of L-lysine selected from the group consisting of: a C₁-C₈ monocarboxylic salt, a C₁-C₈ hydroxyl-substituted dicarboxylic salt, a C₁-C₈ hydroxyl-substituted, carboxyl-substituted dicarboxylic salt, and a combination thereof.

9. The food composition of claim 1 wherein the added L-lysine comprises an unsubstituted C₁-C₈ dicarboxylic salt.

10. The food composition of claim 1 wherein the added L-lysine comprises an L-lysine hydrate.

11. The food composition of claim 1 wherein the added L-lysine comprises an L-lysine hydrochloride.

12. The food composition of claim 1 wherein the food is a tree nut.

13. The food composition of claim 1 wherein the food is selected from the group consisting of: a tree nut milk and a tree nut butter.

14. The food composition of claim 12 wherein the tree nut is selected from the group consisting of: almonds, Brazil nuts, cashews, chestnuts, hazelnuts, macadamia nuts, pecans, pine nuts, pistachios, and walnuts.

15. The food composition of claim 1 wherein the food is a peanut.

16. The food composition of claim 1 wherein the food is selected from the group consisting of: a peanut milk and a peanut butter.

17. The food composition of claim 1 wherein the food is an edible seed.

18. A food product comprising a food composition according to claim 1.

19. A method of producing a nutrient modified food composition, comprising:
providing a food having an amount of endogenous L-lysine and an amount of endogenous L-arginine, wherein the amount of endogenous L-lysine is less than the amount of endogenous L-arginine; and
applying an amount of exogenous L-lysine to the food, the amount of exogenous L-lysine in combination with the amount of endogenous L-lysine sufficient to equal or exceed the amount of endogenous L-arginine, thereby producing a nutritionally balanced food composition.

20. A food composition intended for human consumption, comprising, in combination:
a food having an amount of endogenous L-lysine and an amount of endogenous L-arginine, wherein the amount of endogenous L-lysine is less than the amount of endogenous L-arginine, with the proviso that the food is not a grain; and
an amount of added L-lysine, the amount of added L-lysine in combination with the amount of endogenous L-lysine sufficient to equal or exceed the amount of endogenous L-arginine, wherein the added L-lysine is formulated as an additive which is substantially free of L-arginine.
